(19) United States
(12) Patent Application Publication
(10) Pub. No.: US 2018/0188824 A1
(43) Pub. Date: Jul. 5, 2018

(54) AUTOCORRECT WITH WEIGHTED GROUP VOCABULARY

(71) Applicant: INTERNATIONAL BUSINESS MACHINES CORPORATION, Armonk, NY (US)

(72) Inventors: Jonathan Dunne, Co Waterford (IE); Robert H. Grant, Austin, TX (US); Jeremy A. Greenberger, Raleigh, NC (US); Trudy L. Hewitt, Cary, NC (US)

(21) Appl. No.: 15/844,196

(22) Filed: Dec. 15, 2017

Related U.S. Application Data
(63) Continuation of application No. 15/397,817, filed on Jan. 4, 2017.

(51) Int. Cl. G06F 3/023; G06F 3/0488; G06F 3/0481; G06F 17/24; G06F 17/27

(52) U.S. Cl. CPC G06F 3/0237; G06F 3/04886; G06F 3/0481; G06F 17/273; G06F 17/24

(57) ABSTRACT

Methods, computer program products, and systems are presented. The method, computer program products, and systems can include, for instance: obtaining entered textual information of a user of a messaging system; and outputting word usage corrective information to the user based on word use accuracy models for first through Nth users of the messaging system, wherein the word use accuracy models for first through Nth users of the messaging system are established by examining messages of the messaging system.

### CROSS-REFERENCE TO RELATED APPLICATION

This application is a continuation of U.S. patent application Ser. No. 15/397,817, filed Jan. 4, 2017, entitled, “Autocorrect with Weighted Group Vocabulary,” the entirety of which is hereby incorporated herein by reference.

### BACKGROUND

Group messaging services are a common way for people to communicate. People use them to keep in touch, make plans, or just generally converse. Different groups of people in different contexts can use vastly different phrasing, terminology, and spelling based on their experiences, especially those relevant to a group. In many cases, a word may not be spelled correctly or it might be a reference to a sentimental place that would not make sense outside of the group. Group messaging services include text message services, email services, chat services, or instant messages services.

### SUMMARY

The shortcomings of the prior art are overcome, and additional advantages are provided, through the provision, in one aspect, of a method. The method can include, for example: obtaining entered textual information of a user of a messaging system; and outputting word usage corrective information to the user based on word use accuracy models for first through Nth users of the messaging system, wherein the word use accuracy models for first through Nth users of the messaging system are established by examining messages of the messaging system.

In another aspect, a computer program product can be provided. The computer program product can include a computer readable storage medium readable by one or more processing unit and storing instructions for execution by one or more processor for performing a method. The method can include for example: obtaining entered textual information of a user of a messaging system; and outputting word usage corrective information to the user based on word use accuracy models for first through Nth users of the messaging system, wherein the word use accuracy models for first through Nth users of the messaging system are established by examining messages of the messaging system.

In a further aspect, a system can be provided. The system can include, for example a memory. In addition, the system can include one or more processor in communication with the memory. Further, the system can include program instructions executable by the one or more processor via the memory to perform a method. obtaining entered textual information of a user of a messaging system; and outputting word usage corrective information to the user based on word use accuracy models for first through Nth users of the messaging system, wherein the word use accuracy models for first through Nth users of the messaging system are established by examining messages of the messaging system.

Additional features are realized through the techniques set forth herein. Other embodiments and aspects, including but not limited to computer program product and system, are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts a system having first through Nth user systems and a manager system having an associated history repository and dictionary in one embodiment;

FIG. 2 is a flowchart depicting operation of a manager system in one embodiment;

FIG. 3 is a diagram illustrating data items that can be stored in a history repository in one embodiment;

FIG. 4 is a user interface for display on a user system illustrating operation of a manager system in one embodiment;

FIG. 5 is a diagram illustrating technical computing advantages of a system in one embodiment;

FIG. 6 depicts a computing node in one embodiment;

FIG. 7 depicts a cloud computing environment in one embodiment; and

FIG. 8 depicts abstraction model layers in one embodiment.

### DETAILED DESCRIPTION

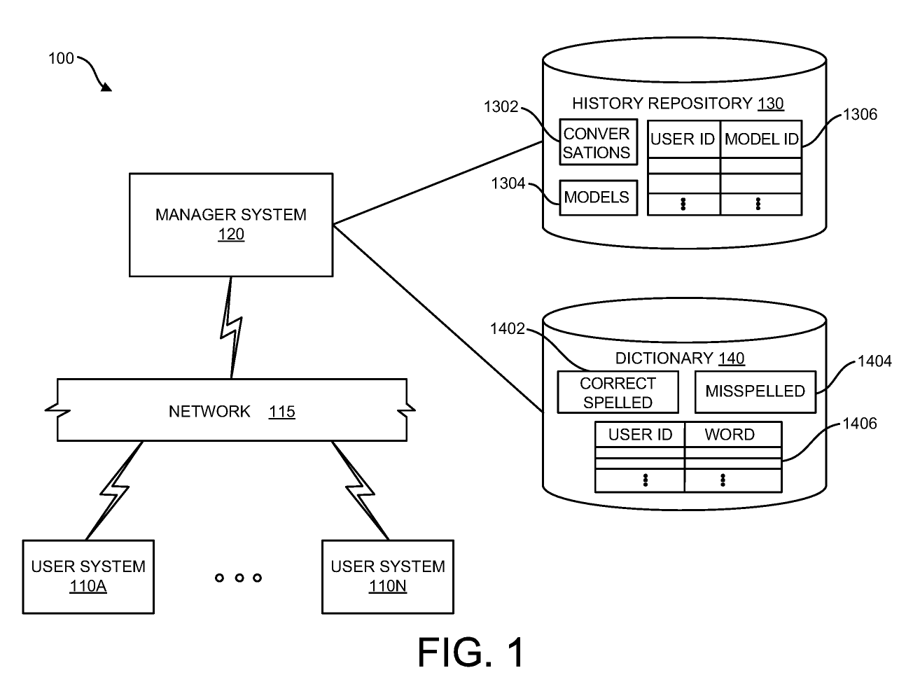

An overview of a system 100 is shown in FIG. 1. System 100 can include first through Nth user systems 110A-110N and manager system 120 connected to first through Nth user systems 110A-110N by a network 115. First through Nth user systems 110A-110N can be computing node based systems. Manager system 120 can be a computing node based system having an associated history repository (HR) 130 and can be operative to obtain messages initiated by users of user systems 110A-110N, to record such messages into history repository 130 and to examine such messages e.g. for establishing word use accuracy models. Manager system 120 can include an associated dictionary database (dictionary) 140 and can be operative to use dictionary 140 to detect new words and can be operative to add new words to dictionary 140.

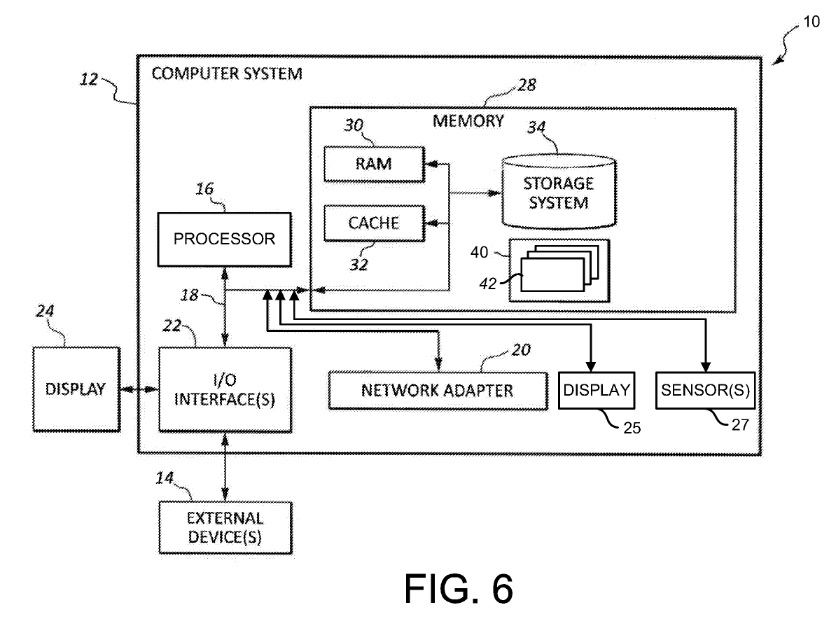

In one embodiment, each of the first through Nth user systems 110A-110N and manager system 120 can include one or more computing node 10 as set forth herein in connection with FIG. 6. In one embodiment, manager system 120 can be configured to provide messaging services to the first through Nth user systems 110A-110N so that system 100 is configured as a messaging system. Messaging services can include e.g. text message services, email services, chat services, or instant messages services. User systems 110A-110N can be provided e.g. by personal computers, laptop computers, smartphones, or the like.

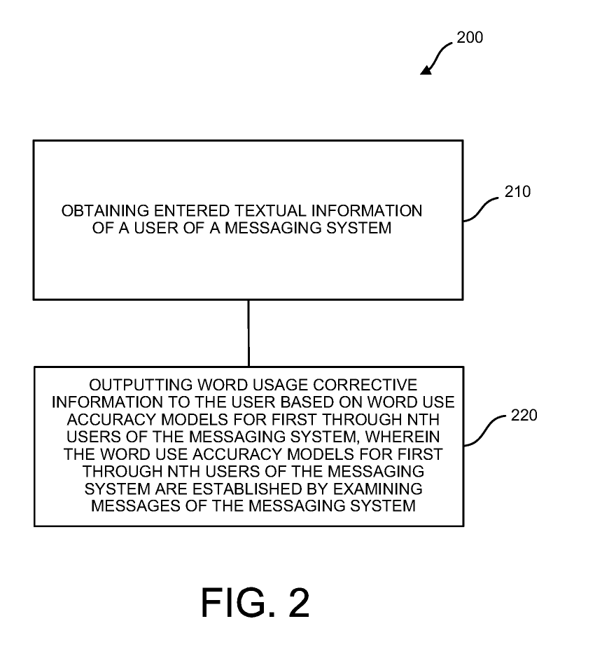

A method 200 that can be performed by manager system 120 in one embodiment is illustrated with reference to FIG. 2. At block 210 method 200 can include obtaining entered textual information of a user of a messaging system. At block 220 method 200 can include outputting word usage corrective information to the user based on word use accuracy models for first through Nth users of the messaging system, wherein the word use accuracy models for first through Nth users of the messaging system are established by examining messages of the messaging system.

In one embodiment, obtaining at block 210 can include receiving by manager system 120 textual information that is entered by a user at one of first through Nth user systems 110A-110N.

In one embodiment, outputting at block 220 can be performed to aid a user entering new text, e.g. for implementation of autocorrect functionality.

In one embodiment, examining at block 220 can include examining messages of users entered into user systems 110A-110N and recorded into history repository 130 by manager system 120. Examining at block 220 can include identifying correctly spelled words and incorrectly spelled words of messages of each of the first through Nth users associated with first through Nth user systems 110A-110N. In one embodiment, outputting at block 210 can be responsive to textual information obtained at block 210.

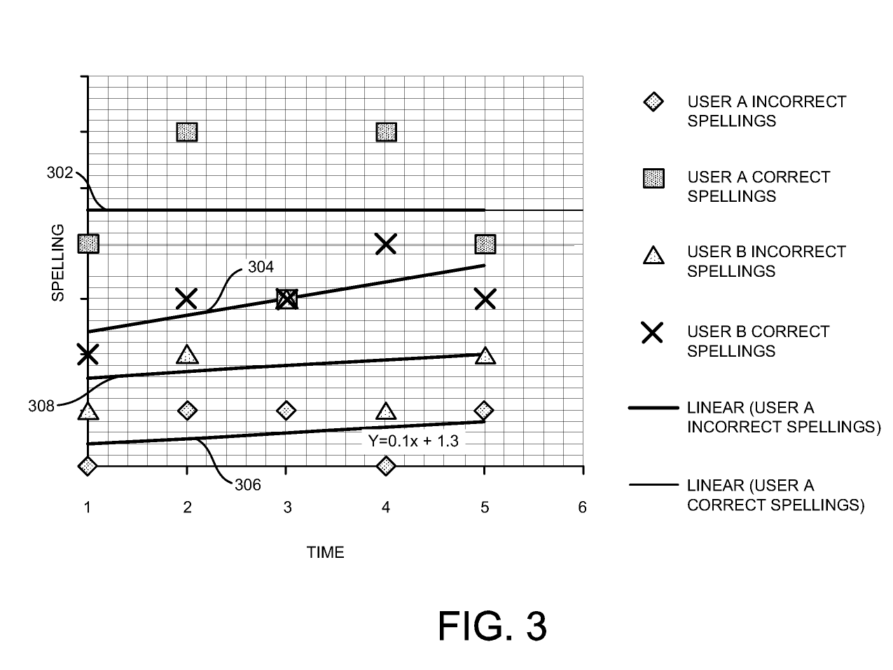

Examining in one embodiment at block 220 is described further in respect to FIG. 3 illustrating the historical data which can be recorded in history repository 130 illustrated with reference to FIG. 1. During various conversations between users using respective user systems 110A-110N manager system 120 can store data of the conversations in conversations area 1302 of history repository 130. Such data can include e.g. original textual content data of messages and/or statistical data determined using original textual content data. Referring to FIG. 3 data of history repository 130 can includes data of each of five conversation times 1 through 5. The times can be time windows and can correspond to different conversations between user A and user B using first and second of first through Nth user systems 110A-110N. The data of FIG. 3 illustrates correctly spelled words versus incorrectly spelled words for first and second users at different conversation times. In the illustrative case user A can have a higher correct spelling rate than user B. The correctly spelled word count for user A for the times 1-5 can be 20-30-15-30-20. The correctly spelled word count for user B for the times 1-5 can be 10-15-15-20-15. The incorrectly spelled word count for user A for the times 1-5 can be 0-5-5-0-5. The incorrectly spelled word count for user B for the times 1-5 can be 5-10-15-5-10.

It will be understood that the data of FIG. 3 includes simplified data simplified to highlight major functional aspects of manager system 120. For example, although correct and incorrect spellings are expressed in terms of a straight count of words, manager system 120 in an implemented embodiment, may employ functions so that accuracy data is normalized between conversations to account for the fact that total word counts of a conversation tend to fluctuate between conversations. Manager system 120 can examine word use accuracy data in addition to or in place of data relating to word spelling.

Manager system 120 can use the data summarized in FIG. 3 for determining word use accuracy models that model word use accuracy behavior for each of the first user A and second user B. Manager system 120 can apply rules in determining word use accuracy models, which models can be stored as model data 1304 of history repository 130. Manager system 120 can use dictionary 140 for determining whether a word of a message is correctly spelled or incorrectly spelled. In one embodiment dictionary 140 can include a correctly spelled word area 1402, a misspelled word area 1404 for common misspellings of words and a new word area having in one embodiment a table 1406, e.g. for new words not included in the correctly spelled word area 1402 or the misspelled word area 1404.

In one embodiment, manager system 120 for determining a word use accuracy model for a user can be operative to count words matching words of the correctly spelled word area 1402 as correct spellings and can be operative to count words matching words of the misspelled word area 1404 as incorrectly spelled words. In one embodiment, subject matter context of a conversation can be used as a filter for detecting whether a spelling is correct or incorrect. For example, in some contexts a spelling of a word may be incorrect and in others correct. In one embodiment, manager system 120 can apply bag of words processing to words of a conversation to determine a subject matter context of a conversation. Manager system 120 can adjust a word use accuracy model for a user for correctly spelled words. Manager system 120 can adjust a word use accuracy model for a user for incorrectly spelled words. Using a word use accuracy model established by manager system 120, manager system 120 can determine that a user having a history of spelling words correctly is likely to have spelled a certain new word correctly. Using a word use model established by manager system 120, manager system 120 can determine that a user having a history of spelling words incorrectly is likely to have spelled a certain new word incorrectly.

In the embodiment described with reference to FIG. 3, manager system 120 can examine word spelling of user messages for establishing word use accuracy models for users. Manager system 120 in addition or in the alternative can examine punctuation and/or grammar of user messages for establishing word use accuracy models for users.

In one embodiment, manager system 120 can establish word use accuracy models for first through Nth users of a manager system 120 wherein the word use accuracy models are configured to perform cognitive computing predictive analytics outputs. For such functioning, word use accuracy models can establish for a user one or more linear regression function for examined data examined by manager system 120. Referring to the data of FIG. 3 manager system 120 can use correctly spelled word data of user A to establish the linear regression function indicated by line 302 for predicting a likelihood of a currently spelled word of user A being spelled correctly. Referring to the data of FIG. 3 manager system 120 can use correctly spelled word data of user B to establish the linear regression function indicated by line 304 for predicting a likelihood of a currently spelled word of user B being spelled correctly. Referring to the data of FIG. 3 manager system 120 can use incorrectly spelled word data of user A to establish the linear regression function indicated by line 306 for predicting a likelihood of a currently spelled word of user A being spelled incorrectly. Referring to the data of FIG. 3 manager system 120 can use incorrectly spelled word data of user B to establish the linear regression function indicated by line 308 for predicting a likelihood of a currently spelled word of user B being spelled incorrectly. Manager system 120 can apply various techniques for line fitting such as least squares estimation and maximum likelihood estimation. In some embodiments, manager system 120 can apply nonparametric regression analyses for establishing non-linear regression functions. By establishing regression functions using time stamped data as shown in FIG. 3 manager system 120 can establish a model useful for predicting a result at a current time using recorded data associated to past times.

In the embodiment of FIG. 3, manager system 120 can establish a generic word use accuracy model, modeling a user's general word use accuracy across all subject matter categories. In another embodiment, manager system 120 can establish M word use accuracy models for a given user for each of M subject matter categories. Manager system 120 can determine a subject matter context of user messages using various tools e.g. by applying a bag of words analysis to the user messages.

Embodiments herein recognize that technical computing advantages can be provided by configuring manager system 120 to perform predictive analytics. For example an effect of spurious data, resulting e.g. from a person typing under abnormal conditions can be diminished. While manager system 120 can establish user word accuracy models that function to perform predictive analytics, manager system 120 can alternatively establish simplified models for modeling word use accuracy, e.g. models that model behavior based on a straight averages of correctly and/or incorrectly spelled words.

Manager system 120 can store in table 1306 of history repository 130 identifiers of users (first column) associated to identifiers for models (second column) for the various users. Models can be stored in history repository 130 as model data 1304 having e.g. one or more of at least one values and at least one functions. Table 1306, by associating identifiers of users to identifiers can associated identifiers of users to models, can associate users to identifiers of models, and can associate users to models.

For outputting word usage corrective information at block 220 based on the word use accuracy models, manager system 120 in one embodiment can provide autocorrect text information for words being entered by a user. In one embodiment, manager system 120 can incorporate autocorrect functionality. With autocorrect functionality active, manager system 120 can output autocorrect data for correction of words as words are being entered, including partial words and complete words. As full or partial words are being entered manager system 120 in accordance with an autocorrect function can display autocorrect information indicating a word or set of words determined to be the most likely word intended to be entered.

In one embodiment, manager system 120 for outputting word usage corrective information at block 220 based on word use accuracy models can use data of table 1306 of history repository 130 as well as table 1406 of dictionary 140. For performance of block 220 manager system 120 can record table 1406 in dictionary 140 and update table 1406 of dictionary 140. Table 1406 of dictionary 140 can be a new word table of dictionary 140 for storage of new words associated to user identifiers for users entering the respective new words. Where a new word is entered by a user, manager system 120 can monitor the new word and can store the new word in table 1406 when the new word is determined to be a new word e.g. by determining that the word is other than an existing standard correctly spelled word of correctly spelled word area 1402 or a commonly misspelled word of misspelled word area 1404. Manager system 120 for configuring manager system 120 to perform block 220 can store in table 1406 a user identifier of the user that entered the new word. Table 1406, by associating identifiers of users to new words, can associate users to new words.

By the storage of a user identifier associated to a new word in table 1406 and by the storage of user identifiers to word use accuracy model identifiers in table 1306 manager system 120 can establish an index for use by manager system 120 that indexes new words of dictionary 140 to word use accuracy models stored in history repository 130 that have been established for various users. Logic can thus be established that uses a history of conversations of users to determine whether a new word is accurately represented.

As noted, for outputting word usage corrective information at block 220 based on word use accuracy models, manager system 120 in one embodiment can output autocorrect text information for words being entered by a user and obtained by manager system 120 at block 210. In one embodiment, manager system 120 for performance of outputting at block 220 can generate candidate lists of words and can determine a prioritization of words of the candidate lists of words. Manager system 120 can output autocorrect text information based on the determined prioritization. For example, manager system 120 can display a most likely intended word in a first area of a displayed user interface and a second most likely intended word in a second area of a displayed user interface. Manager system 120 can employ pattern recognition algorithms e.g. classification algorithms and/or clustering algorithms for generation of candidate lists of words.

In the case that candidate lists of words generated by manager system 120 include only words from standard correctly spelled word area 1402, manager system 120 can use one or more criteria e.g. using word subject matter context algorithms and or grammar check algorithms for determining a prioritization of the candidate words. In the case that candidate lists of words generated by manager system 120 include words from the new word area of dictionary 140 having table 1406, manager system 120 can use word use accuracy models identified in table 1306 of history repository 130, and zero or more additional criteria (e.g. including using word subject matter context algorithms and/or grammar check algorithms) for determining a prioritization of the candidate words.

In one embodiment, manager system 120 for determining a prioritization of candidate words that include new words can score the candidate words using word use accuracy models associated to the candidate words. As noted word use accuracy models can be associated to new words based on a new word being associated to a certain user when manager system 120 recognizes that a new word has been entered. Referring to the example of FIG. 3, a candidate set of words generated by manager system 120 can include a candidate new word “wordA” originally entered into manager system 120 by user A and a new word “wordB” originally entered into manager system 120 by user B. Using models defined by the linear regression functions represented in FIG. 3 manager system 120 can output a scoring parameter score indicating a likelihood of an arbitrary current word usage of user A (and accordingly the candidate word of user A) being correct and can output a scoring parameter score indicating a likelihood of an arbitrary current word usage of user B (and accordingly the candidate word of user B) being correct and can prioritize the candidate new words associated with user A and user B respectively based on the candidate word having a higher scoring parameter score.

As noted, for outputting word usage corrective information at block 220 based on the word use accuracy models, manager system 120 in one embodiment can provide autocorrect text information for words being entered by a user. In embodiment, manager system 120 can perform outputting word usage corrective information at block 220 based on the word use accuracy models with use of the processing described, e,g. including looking up in table 1406 of dictionary 140 user identifiers associated to a set of candidate words, scoring the likelihood of correctness of the candidate words of the set of candidate words using word use accuracy models identified in table 1306 associated to the users and user identifiers, and performing prioritization of the candidate words based on the scoring parameter score of the respective candidate words.

Example 1 herein illustrates an embodiment of manager system 120 for performance of outputting word usage corrective information at block 220.

### Example 1

A new restaurant called Anthony Bourdain's and users in a group chat decide to make plans with each other to go there for dinner. Currently the phrase “Anthony Bourdain's” is not part of a dictionary and has not previously been used by the group messaging users. The first user sends a chat textual message “Hey guys, let's meet up at that new place Antoni Bourdain's?” A second user sends the textual message “Sure, AntonyBourdain's at 8.” A third user send the textual message: “Sounds good to me, see you guys at Anthony Bourdain's.” In the described textual conversation there are three derivative spellings of “Anthony Bourdain's” but the third user has shown more accuracy in previous spellings than users 1 or 2, and in the particular example the first user has shown greater accuracy that the second user.

In the described example manager system 120 can be operative to recognize the different derivative spelling of “Anthony Bourdain's” as new words and can store each new word in new word table 1406 of a new word area of dictionary 140 and can associate an identifier of the user of the new word to the new word by storing the identifier identifying the originator of the word in dictionary 140. History repository 130 can store model data 1304 modeling word accuracy usage of the first, second and third user. The models defined by model data 1304 can be based on data of the current textual conversation as well as past textual conversations in which the third user has shown the highest accuracy in word usage, the first user the second highest and the second user the third highest.

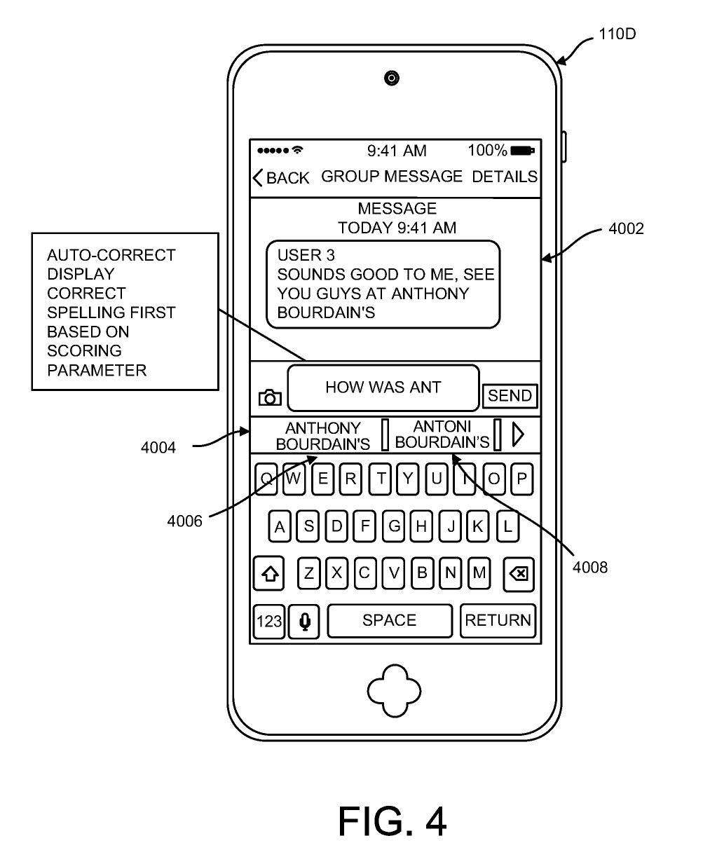

An embodiment of manager system 120 performing outputting corrective information at block 220 in accordance with Example 1 is illustrated with reference to FIG. 4, showing user system 110D of the fourth user in the process of entering the textual message: “How was Anthony Bourdain's”? Referring to FIG. 4, manager system 120 can output a user interface 4002 for display on a display of a user system that can provide user interactive feedback to a user while a user types in a new textual message into the user interface 4002. On entering “ANT” manager system 120 can generate a list of candidate words using pattern recognition algorithms and can determine a prioritization for the candidate words based on scoring parameters for each candidate word using user word use accuracy models of history repository 130 as set forth herein. Manager system 120 can display “Anthony Bourdain's”, the spelling in the highest priority section 4006 of autocorrect text area 4004, based on manager system 120 determining the particular spelling “Anthony Bourdain's” has the highest scoring parameter score of the candidate words. Manager system 120 can display “Antoni Bourdain's”, the spelling in the second highest priority section 4008 of autocorrect text area 4004, based on manager system 120 determining the particular spelling “Antoni Bourdain's” has the second highest scoring parameter score of the candidate words.

### End of Example 1

In another embodiment, past word usages need not be used and Naïve Bayes method can be used for auto-correction. According to a Naïve Bayes method, all derivative spellings may be given equal priority until the same derivative spelling is used repeatedly, and then manager system 120 can determine a most repeated spelling to be the correct spelling. According to such method, priority may be arbitrarily assigned to any spelling e.g. a first spelling. Accordingly, with implementation of an alternative Naïve Bayes method, the highest priority section 4006 of autocorrect text area 4004 may have the textual content Antoni Bourdain's″.

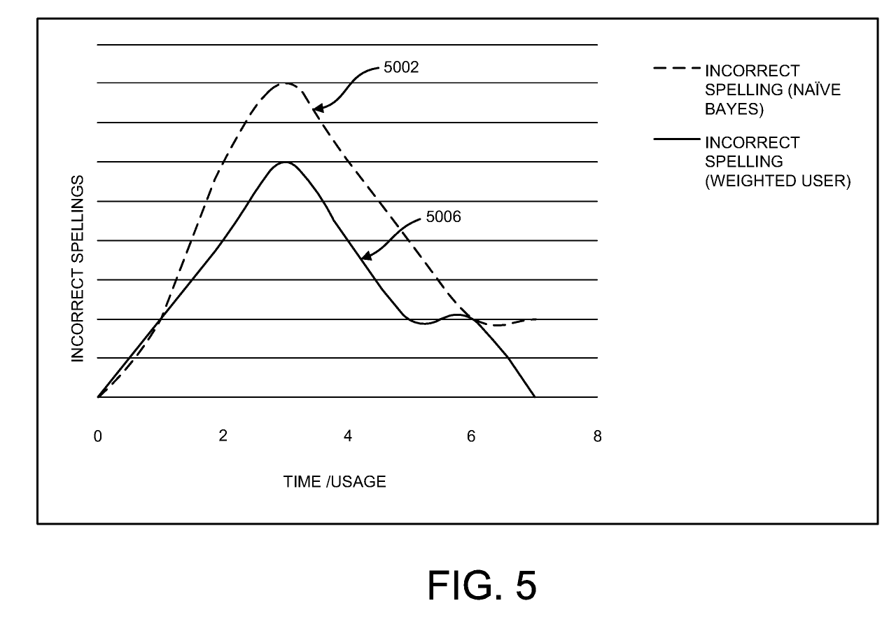

FIG. 5 illustrates technical computing advantages that may be achievable with use of method 200. Plot 5002 illustrates expected incorrect spellings over time using a Naïve Bayes method for performance of auto-correction and plot 5006 illustrates expected incorrect spellings over time using block 220 of method 200 for performance of auto-correction. Embodiments herein recognize that with use of a Naïve Bayes auto-correction a high error rate can be expected to be associated for early conversations. As correction logic cannot emerge until after there are repeated common spellings, embodiments herein recognize that delays are possible or likely. Referring to plot 5006 embodiments herein recognize that the time for misspellings to can be expected to be reduced with the use of the outputting as set forth at block 220 as decision logic is no longer tied to repeated use. As unnecessary data no longer needs to be generated or recorded memory storage efficiencies can result from performance of method 200. Certain embodiments herein may offer various technical computing advantages, including providing rapid updates to group vocabularies, by means which can include in one embodiment a history repository 130 storing in past conversation data and using such data to determine word use accuracy models for various users. In one embodiment that employs use of data to a history repository 130 a time to decision curve, e.g. as shown in FIG. 5 can be flattened and shortened relative to an anticipated time to decision curve in the case of an alternative embodiment using Naïve Bayes processing.

In one embodiment manager system 120 can provide Naïve Bayes processing in combination with the processing set forth with reference to method 200 described in connection with the flowchart of FIG. 2. For example, manager system 120 can use method 200 described in the flow chart of FIG. 2 to determine word usage corrective information, e.g. a corrective prompt in the case a count of a word and derivative spellings of the word is below a threshold, and manager system 120 can use Naïve Bayes processing to determine word usage corrective information, e.g. a corrective prompt in the case the count is above a threshold. In such manner, repeated same spellings may be used to control autocorrect prompts (and not user word use accuracy models) in the case there are more than a threshold number of uses of new word having multiple derivative spellings in a conversation history, and user word use accuracy models can be used to control output of word usage information in the case there are less than a threshold number of uses of new word having multiple derivative spellings in a conversation history.

With word use accuracy models configured as described manager system 120 can be operative so that an accuracy with which manager system 120 prioritizes lists of words for determining information autocorrect information is improved overtime. Based on the foregoing system it will be seen that manager system 120 can repeatedly update model data defining word use accuracy models modeling word use accuracy of users over time. For example, during each textual conversation of a user, e.g. user A described in reference to FIG. 3, manager system 120 can update linear regression functions such as the functions indicated by line 302 and line 306 based on the current conversation data, e.g. count of words spelled correctly and incorrectly. Accordingly manager system 120 accesses the model for user A for determining a prioritization, e.g. when manager system 120 generates a candidate list of words that may be displayed for an autocorrect prompt and one of the words was a word recorded in dictionary 140 first entered by user A, manager system 102 can use the most recently updated model of history repository 130 modeling user A's word use accuracy behavior. There is set forth herein in the context of model data that is updated, the method including performing the obtaining and the outputting (blocks 210 and 220 of FIG. 2) at a first time and performing a second performing of the obtaining and outputting (blocks 210 and 220) at a second time, wherein for the second performing the word use accuracy models for first through Nth users include updated word use accuracy models for the first through Nth users updated by examining messages of users of the first through Nth users recorded between the first and second time.

FIGS. 6-8 depict various aspects of computing, including a computer system and cloud computing, in accordance with one or more aspects set forth herein.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 6, a schematic of an example of a computing node is shown. Computing node 10 is only one example of a suitable computing node and is not intended to suggest any limitation as to the scope of use or functionality of embodiments of the invention described herein. Regardless, computing node 10 is capable of being implemented and/or performing any of the functionality set forth hereinabove. Computing node 10 can be implemented as a cloud computing node in a cloud computing environment, or can be implemented as a computing node in a computing environment other than a cloud computing environment. Each of vehicle system 110, vehicle system 112, and manager system 120 as set forth in FIG. 1 can include one or more computing node.

In computing node 10 there is a computer system 12, which is operational with numerous other general purpose or special purpose computing system environments or configurations. Examples of well-known computing systems, environments, and/or configurations that may be suitable for use with computer system 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system 12 may be described in the general context of computer system-executable instructions, such as program processes, being executed by a computer system. Generally, program processes may include routines, programs, objects, components, logic, data structures, and so on that perform particular tasks or implement particular abstract data types. Computer system 12 may be practiced in distributed cloud computing environments where tasks are performed by remote processing devices that are linked through a communications network. In a distributed cloud computing environment, program processes may be located in both local and remote computer system storage media including memory storage devices.

As shown in FIG. 6, computer system 12 in computing node 10 is shown in the form of a general-purpose computing device. The components of computer system 12 may include, but are not limited to, one or more processor 16, a system memory 28, and a bus 18 that couples various system components including system memory 28 to one or more processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 12 typically includes a variety of computer system readable media. Such media may be any available media that is accessible by computer system 12, and it includes both volatile and non-volatile media, removable and non-removable media.

System memory 28 can include computer system readable media in the form of volatile memory, such as random access memory (RAM) 30 and/or cache memory 32. Computer system 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program processes that are configured to carry out the functions of embodiments of the invention.

One or more program 40, having a set (at least one) of program processes 42, may be stored in memory 28 by way of example, and not limitation, as well as an operating system, one or more application programs, other program processes, and program data. One or more program 40 including program processes 42 can generally carry out the functions set forth herein e.g. the functions set forth with reference to the flowchart of FIG. 2 which can be performed by manager system 120 and as further described in connection with FIG. 1 and FIGS. 3-5.

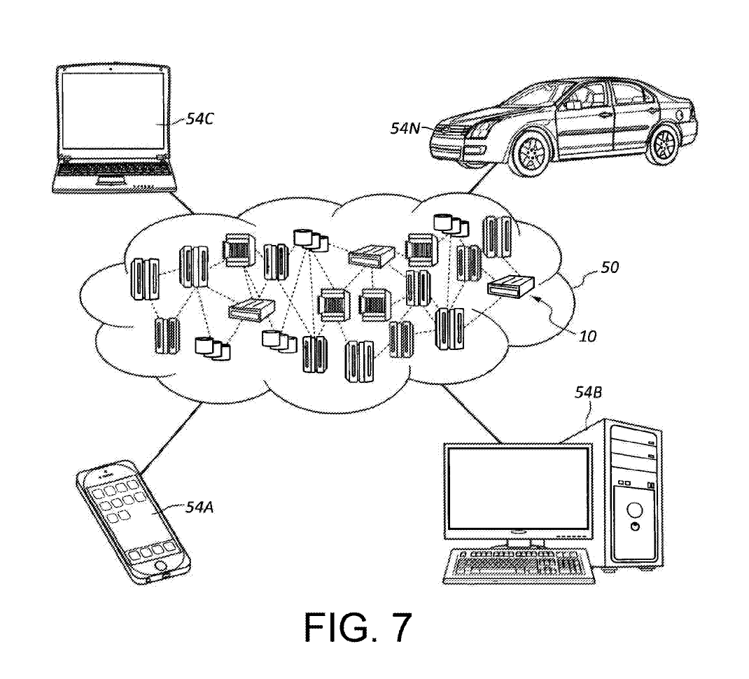

Computer system 12 may also communicate with one or more external devices 14 such as a keyboard, a pointing device, a display 24, etc.; one or more devices that enable a user to interact with computer system 12; and/or any devices (e.g., network card, modem, etc.) that enable computer system 12 to communicate with one or more other computing devices. Such communication can occur via Input/Output (I/O) interfaces 22. Still yet, computer system 12 can communicate with one or more networks such as a local area network (LAN), a general wide area network (WAN), and/or a public network (e.g., the Internet) via network adapter 20. As depicted, network adapter 20 communicates with the other components of computer system 12 via bus 18. It should be understood that although not shown, other hardware and/or software components could be used in conjunction with computer system 12. Examples, include, but are not limited to: microcode, device drivers, redundant processing units, external disk drive arrays, RAID systems, tape drives, and data archival storage systems, etc. In addition to or in place of having external devices 14 and display 24, which can be configured to provide user interface functionality, computing node 10 in one embodiment can include display 25 connected to bus 18. In one embodiment, display 25 can be configured as a touch screen display and can be configured to provide user interface functionality. Computer system 12 in one embodiment can also include one or more sensor device 27 connected to bus 18. One or more sensor device 27 can alternatively be connected through I/O interface(s) 22. One or more sensor device 27 can include a Global Positioning Sensor (GPS) device in one embodiment and can be configured to provide a location of computing node 10. In one embodiment, one or more sensor device 27 can alternatively or in addition include, e.g., or more of a camera, a gyroscope, a temperature sensor, a humidity sensor or an audio input device. Computer system 12 can include one or more network adapter 20. In reference to FIG. 7 below computing node 10 is implemented in a cloud environment and hence is referred to as a cloud computing node in the context of FIG. 7.

Referring now to FIG. 7, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

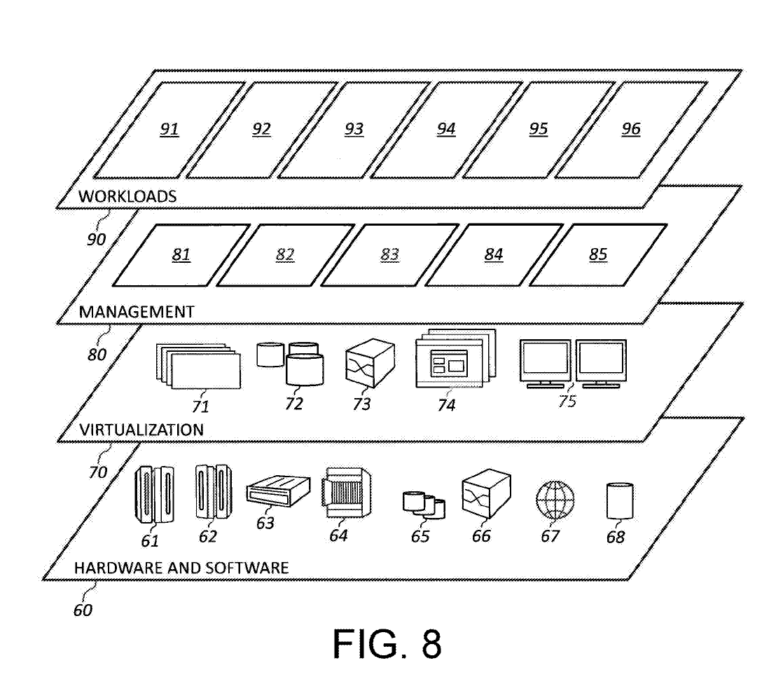

Referring now to FIG. 8, a set of functional abstraction layers provided by cloud computing environment 50 (FIG. 8) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and processing components 96 for enhancing messaging service services as set forth in the flowchart of FIG. 2 and in connections with FIG. 1 and FIGS. 3-5. The processing components 96 can be performed by one or more program 40 described in FIG. 6.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Forms of the term “based on” herein encompass relationships where an element is partially based on as well as relationships where an element is entirely based on. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. Where methods, computer program products, or systems are described as having a certain number of elements, the methods, computer program products, or systems can be practiced with less than or greater than the certain number of elements. The description set forth herein has been presented for purposes of illustration and description, but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated.

What is claimed is:

1. A method comprising:
obtaining, by one or more processor, entered textual information of a user of a messaging system; and
outputting, by the one or more processor, word usage corrective information to the user based on word use accuracy models for first through Nth users of the messaging system, wherein the word use accuracy models for first through Nth users of the messaging system are established by examining messages of the messaging system.

2. The method of claim 1, wherein the examining includes examining data of past textual conversations of the first through Nth users stored in a history repository.

3. The method of claim 1, wherein the word use accuracy models include one or more linear regression function for performance of predictive analytics.

4. The method of claim 1, wherein the outputting includes generating a list of candidate words and determining a prioritization of the candidate words using models of the word use accuracy models for first through Nth users of the messaging system.

5. The method of claim 1, wherein the outputting includes generating a list of candidate words and determining a prioritization of the candidate words using a scoring that is determined based on a stored data structure data that indexes originators of the candidate words to word use accuracy models for the originators of the candidate words.

6. The method of claim 1, wherein the outputting includes generating a list of candidate words and determining a prioritization of the candidate words using a scoring that is determined based on a stored data structure data that indexes originators of the candidate words to word use accuracy models for the originators of the candidate words, the stored data structure data including a first data structure provided by a table that associates new words to users of the first through Nth users originating the new words, and a second data structure provided by a table that associates the first through Nth users to model data defining word use accuracy models for the first through Nth users.

7. The method of claim 1, wherein the examining includes examining data of a history repository for counting a number of correctly spelled words and counting a number of incorrectly spelled words in past textual conversations of each user of the first through Nth users.

8. (canceled)

9. The method of claim 1 wherein the outputting includes establishing a prioritization of candidate words and displaying the word usage corrective information according to the prioritization.

10. The method of claim 1, wherein the method includes performing the obtaining and outputting at a first time and performing a second performing of the obtaining and outputting at a second time, wherein for the second performing the word use accuracy models for first through Nth users include updated word use accuracy models for the first through Nth users updated by examining messages of users of the first through Nth users recorded between the first and second time.

11. (canceled)

12. The method of claim 1, wherein the outputting is responsive to the entered textual information.

13. The method of claim 1, wherein a first word use accuracy model of the word use accuracy models is a model that models word use accuracy of the first of the first through Nth users, wherein a second word use accuracy model of the word use accuracy models is a model that models word use accuracy of a second user of the first through Nth users, and wherein an Nth word use accuracy model of the word use accuracy models is a model that models word use accuracy of the Nth user of the first through Nth users.

14. The method of claim 1, wherein a first word use accuracy model of the word use accuracy models is a model that models word use accuracy of the first of the first through Nth users, wherein a second word use accuracy model of the word use accuracy models is a model that models word use accuracy of a second user of the first through Nth users, and wherein an Nth word use accuracy model of the word use accuracy models is a model that models word use accuracy of the Nth user of the first through Nth users, wherein each user of first through Nth users has a different word use accuracy model of the word use accuracy models that models that user's word use accuracy.

15. A method comprising:
obtaining, by one or more processor, entered textual information of a user of a messaging system, and
outputting, by the one or more processor, word usage corrective information to the user based on a set of word use accuracy models, wherein each user of first through Nth users has a word use accuracy model of the set of word use accuracy models that models that user's word use accuracy, wherein the word use accuracy models for the first through Nth users of the messaging system are established by examining messages of the messaging system.

16. The method of claim 15, wherein the examining includes examining data of past textual conversations of the first through Nth users stored in a history repository, wherein the word use accuracy models include one or more linear regression function for performance of predictive analytics, wherein the outputting includes generating a list of candidate words and determining a prioritization of the candidate words using models of the word use accuracy models for first through Nth users of the messaging system so that a candidate word originated by a first user is assigned a prioritization higher than a candidate word originated by a second user based on the first word use accuracy model modeling the first user as a more accurate speller than the second user having word use accuracy modeled by the second word use accuracy model.

17. The method of claim 15, wherein a first word use accuracy model of the word use accuracy models is a model that models word use accuracy of the first of the first through Nth users, wherein a second word use accuracy model of the word use accuracy models is a model that models word use accuracy of a second user of the first through Nth users, and wherein an Nth word use accuracy model of the word use accuracy models is a model that models word use accuracy of the Nth user of the first through Nth users, wherein each user of first through Nth users has a different word use accuracy model of the word use accuracy models that models that user's word use accuracy.

18. The method of claim 15, wherein the first through Nth users include a first user and second user, wherein the word use accuracy models for the first through Nth users include a first word use accuracy model that models the word use accuracy of the first user, and a second word use accuracy model that models the word use accuracy of the second user, wherein the outputting includes generating a list of candidate words and determining a prioritization of the candidate words using models of the word use accuracy models for first through Nth users of the messaging system so that a candidate word originated by a first user is assigned a prioritization higher than a candidate word originated by a second user based on the first word use accuracy model modeling the first user as a more accurate speller than the second user having word use accuracy modeled by the second word use accuracy model.

19. The method of claim 15, wherein the outputting includes generating a list of candidate words and determining a prioritization of the candidate words using a scoring that is determined based on a stored data structure data that indexes originators of the candidate words to word use accuracy models for the originators of the candidate words.

20. The method of claim 15, wherein the first through Nth users include a first user and second user, wherein the word use accuracy models for the first through Nth users include a first word use accuracy model that models the word use accuracy of the first user, wherein the outputting includes generating a list of candidate words and determining a prioritization of the candidate words using a scoring that is determined based on a stored data structure data that indexes originators of the candidate words to word use accuracy models for the originators of the candidate words, the stored data structure data including a first data structure provided by a table that associates new words to users of the first through Nth users originating the new words, and a second data structure provided by a table that associates the first through Nth users to model data defining word use accuracy models for the first through Nth users.

21. The method of claim 15, wherein the first through Nth users include a first user and second user, wherein the word use accuracy models for the first through Nth users include a first word use accuracy model that models the word use accuracy of the first user, and a second word use accuracy model that models the word use accuracy of the second user.

22. The method of claim 15, wherein the first through Nth users include a first user and second users, wherein the word use accuracy models for the first through Nth users include a first word use accuracy model that models the word use accuracy of the first user, and a second word use accuracy model that models the word use accuracy of the second user, wherein the outputting includes generating a list of candidate words and determining a prioritization of the candidate words using a scoring that is determined based on a stored data structure data that indexes originators of the candidate words to word use accuracy models for the originators of the candidate words so that a candidate word originated by a first user is assigned a prioritization higher than a candidate word originated by a second user based on the first word use accuracy model modeling the first user as a more accurate speller than the second user having word use accuracy modeled by the second word use accuracy model.
